(19) United States
(12) Patent Application Publication
(10) Pub. No.: US 2006/0114270 A1
(43) Pub. Date: Jun. 1, 2006

(54) Method and apparatus for color-compensating for aging in a display module

(76) Inventors: Hung-Min Shih, Lugang Township (TW); Chung-Kuang Tsai, Jhudong Township (TW)

Correspondence Address: RABIN & Berdo, PC, 1101 14TH STREET, NW, SUITE 500, WASHINGTON, DC, 20005, US

(21) Appl. No.: 11/137,434

(22) Filed: May 26, 2005

(30) Foreign Application Priority Data
Nov. 26, 2004 (TW) 93136635

(51) Int. Cl. G09G 5/10

(52) U.S. Cl. 345/690

(57) ABSTRACT

A spontaneously color compensating control apparatus is provided for performing spontaneous color compensation on the original pixel data and outputting compensated pixel data to a display module accordingly. The control apparatus includes a timer and a timing controller. The timer is used for providing the using time of the display module and the timing controller is used to receive the original pixel data and output the compensated pixel data. The timing controller adjusts the gray levels of the original pixel data to output the compensated pixel data according to the using time of the display module.

This application claims the benefit of Taiwan application Serial No. 93136635, filed Nov. 26, 2004, the subject matter of which is incorporated herein by reference.

### BACKGROUND OF THE INVENTION

1. Field of the Invention

The invention relates in general to a method and apparatus for color-compensating for aging in a display module, and more particularly to a method and apparatus for color-compensating for aging in a non-self-illumination display module so as to elongate lifetime of the display module.

2. Description of the Related Art

Referring to FIG. 1, a structure diagram of the conventional liquid crystal display is shown. The liquid crystal display 100 includes a control circuit 110 and a display module 120. The control circuit 110 includes a timing controller 112 and the display module 120 includes a data driver 122, a display panel 124 and a scan driver 126. The data driver 122 outputs data voltages to the display panel 124 according to the pixel data Dp and the clock signal CLK output by the timing controller 112. The scan driver 126 actuates pixel control switches raw by raw to display the corresponding images on the display panel 124 according to the gate IC clock signal output by the timing controller 112.

The lifetime of present display panels 124 is demanded at least 50000 hours to 60000 hours. However, for plastic thin film part of the display module 120, such as the backlight module and the polarizing plate, is easily damaged after used for a long time, the aging effect, occurred on the display module 120, influences the gray level display of the display panel 124. Therefore, the lifetime of the liquid crystal display 100 is reduced.

### SUMMARY OF THE INVENTION

It is therefore an object of the invention to provide a spontaneously color compensating control apparatus and method thereof. According to the using time of the display module, the display can perform spontaneous color compensation to prevent the above-mentioned aging effect occurred as the display panel is used for a long time and thus elongate the display's lifetime.

The invention achieves the above-identified object by providing a spontaneously color compensating control apparatus for performing spontaneous color compensation on original pixel data and outputting compensated pixel data to a display module accordingly. The control apparatus includes a timer and a timing controller. The timer is used for providing the power-on time duration of the display module. The timing controller is used for receiving the original pixel data and outputting the compensated pixel data. The timing controller adjusts gray levels of the original pixel data to output the compensated pixel data according to the power-on time duration.

The invention achieves the above-identified object by providing a spontaneously color compensating control apparatus for performing spontaneous color compensation on original pixel data and outputting compensated pixel data to a display module accordingly. The control apparatus includes a timer, a timing controller, and a compensating control unit. The timer is used for providing the power-on time duration of the display module. The timing controller is used for receiving the original pixel data and outputting a data requiring signal. The compensating control unit, including a look-up table, is used for checking the look-up table to output the corresponding calibrating signal according to the data requiring signal and the power-on time duration.

The invention achieves the above-identified object by providing a spontaneously color compensating control method for performing spontaneous color compensation on original pixel data and outputting compensated pixel data to a display module accordingly. The method includes calculating the power-on time duration of the display module; and adjusting gray levels of the original pixel data to generate the compensated pixel data according to the power-on time duration.

The invention achieves the above-identified object by providing a spontaneously color compensating control method for performing spontaneous color compensation on original pixel data and outputting compensated pixel data to a display module accordingly. The control method includes providing the power-on time duration of the display module; providing a data requiring signal; providing a calibrating signal by checking a look-up table according to the data requiring signal and the power-on time duration; and compensating the original pixel data according to the calibrating signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a structure diagram of the conventional liquid crystal display.

FIG. 2A is a structure diagram of the spontaneously color compensating control apparatus of the liquid crystal display according to a preferred embodiment of the invention.

FIG. 2B is a circuit diagram of the data requiring signal output of the EEPROM controlled by the timer in FIG. 2A.

FIG. 2C is a circuit diagram of the data requiring signal output of the timing controller controlled by the timer in FIG. 2A.

FIG. 3A is a flow chart of spontaneously color compensating control method of the liquid crystal display according to the preferred embodiment of the invention.

FIG. 3B shows the red, green, and blue gray levels provided by the first look-up table and the second look-up table.

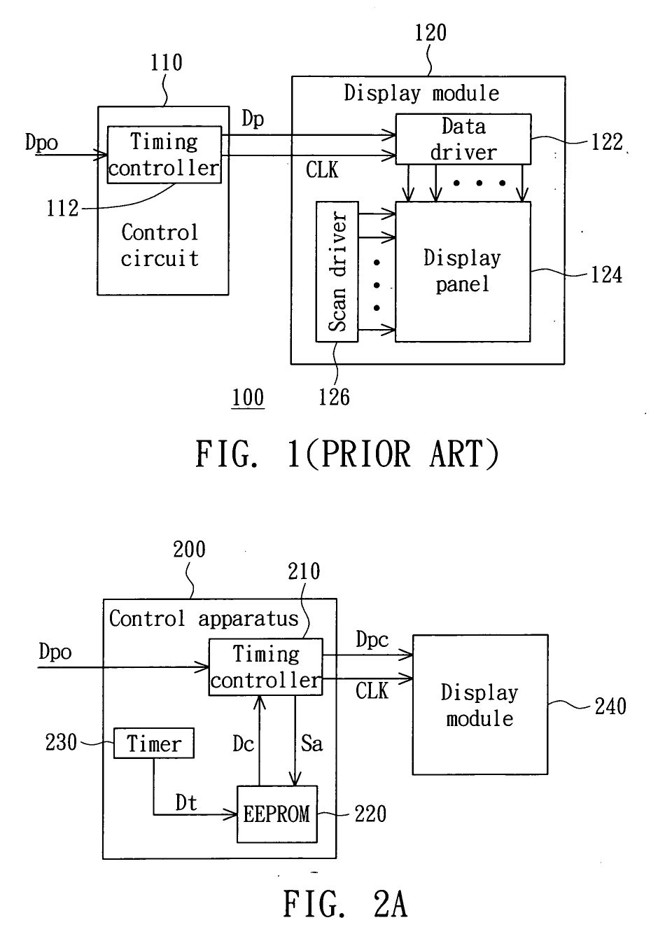

### DETAILED DESCRIPTION OF THE INVENTION

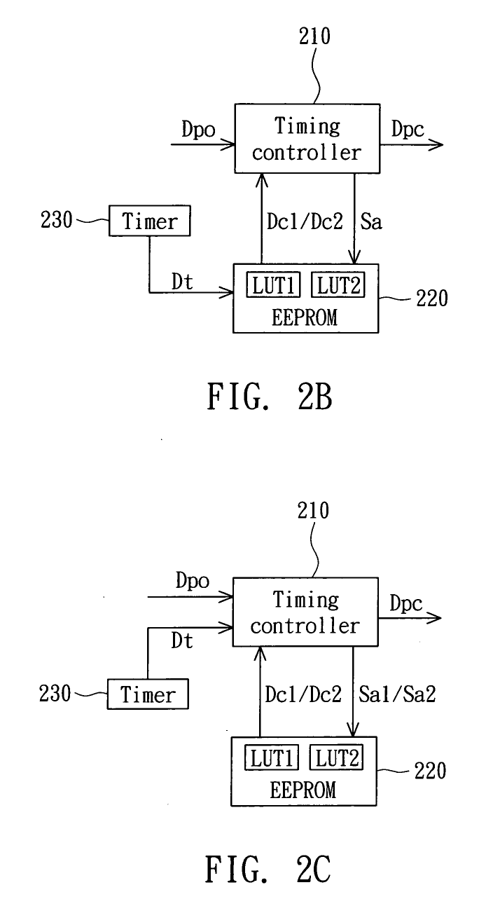

Referring to FIG. 2A, a structure diagram of the spontaneously color compensating control apparatus of the liquid crystal display according to a preferred embodiment of the invention is shown. The color compensating control apparatus 200 is used for performing spontaneous color compensation on the original pixel data Dpo and outputting compensated pixel data Dpc to the display module 240. The control apparatus 200 includes a timing controller 210, an electrically erasable & programmable read-only memory (EEPROM) 220 and a timer 230. The timer 230 is used for calculating the power-on time duration of the display module 240, which means the time of using the display module 240 since the first power-on. The timing controller 210 performs spontaneous color compensation on original pixel data Dpo and outputs compensated pixel data Dpc and clock signals CLK to the display module 240 for display images according to the power-on time duration of the display module 240. In the following description, the above-mentioned electrically erasable & programmable read-only memory 220 is represented by EEPROM.

The timer 230 is coupled to the EEPROM 220 and the EEPROM 220 is coupled to the timing controller 210 for storing a number of look-up tables. The look-up tables are used to provide the required pixel gray levels for the timing controller to compensate original pixel data Dpo in different power-on time duration of the display module 240. As shown in FIG. 2A, the timing controller 210 outputs a data requiring signal Sa to the EEPROM 220 while the EEPROM 220 responses a calibrating signal Dc to the timing controller 210 according to the data requiring signal Sa and time using data Dt output by the timer 230 corresponding to the power-on time duration of the display module 240. Therefore, the timing controller 210 can compensate the original pixel data Dpo to output the compensated pixel data Dpc according to the calibrating signal Dc.

As shown in FIG. 2B, when the liquid crystal display is just actuated, the timing controller 210 outputs the data requiring signal Sa to the EEPROM 220. The EEPROM 220 checks the first look-up table LUT1 to output the first calibrating signal Dc1 according to the data requiring signal Sa and the time using data Dt. The first calibrating signal Dc1 provides the percentage of the red, green, and blue gray levels, such as 255:255:255, and the timing controller 210 can adjust the original pixel data Dpo according to the gray-level percentage and generate compensated pixel data Dpc accordingly.

When the display module 240 has been used for a predetermined period of time, such as 5000 hours, the aging effect will be occurred on the display panel. Therefore, the control apparatus 200 performs the first spontaneous color compensation in which the EEPROM 220 checks the second look-up table LUT2 to output the second calibrating signal Dc2 according to the data requiring signal Sa and the time using data Dt. The calibrating signal Dc2 provides the percentage of the red, green, and blue gray levels of the pixel data Dpc, such as 255:250:250, for the timing controller 210 to adjust the original pixel data Dpo and generate compensated pixel data Dpc accordingly. Therefore, by reducing the green and blue gray levels, the normal color display of the display panel can be maintained.

Moreover, when the accumulative time of using the display module 240 reaches 8000 hours or 10000 hours, the above-mentioned aging effect is even more serious. The control apparatus 200 can spontaneously perform the second or the third color compensation. The EEPROM 220 can check the third and the fourth stored look-up tables to compensate the original pixel data Dpo and generate the required calibrating pixel data Dpc.

Furthermore, as shown in FIG. 2C, the control apparatus 200 of the invention can be also coupled to the timing controller 210. The timing controller 210 receives the time using data Dt corresponding to the power-on time duration of the display module 240 and combines the time using data Dt into the data requiring signal to output. Before the power-on time duration of the display module 240 reaches the predetermined time, the timing controller 210 outputs the first data requiring signal Sa1, and the EEPROM 220 checks the first look-up table LUT1 to output the first compensated signal Dc1 according to the first data requiring signal Sa1. When the power-on time duration reaches the predetermined time, the timing controller 210 outputs the second data requiring signal Sa2 and the EEPROM 220 checks the second look-up table LUT2 to output the second calibrating signal Dc2 according to the second data requiring signal Sa2. The timing controller 210 then outputs the compensated pixel data Dpc according to the first or the second calibrating signal Dc1 or Dc2.

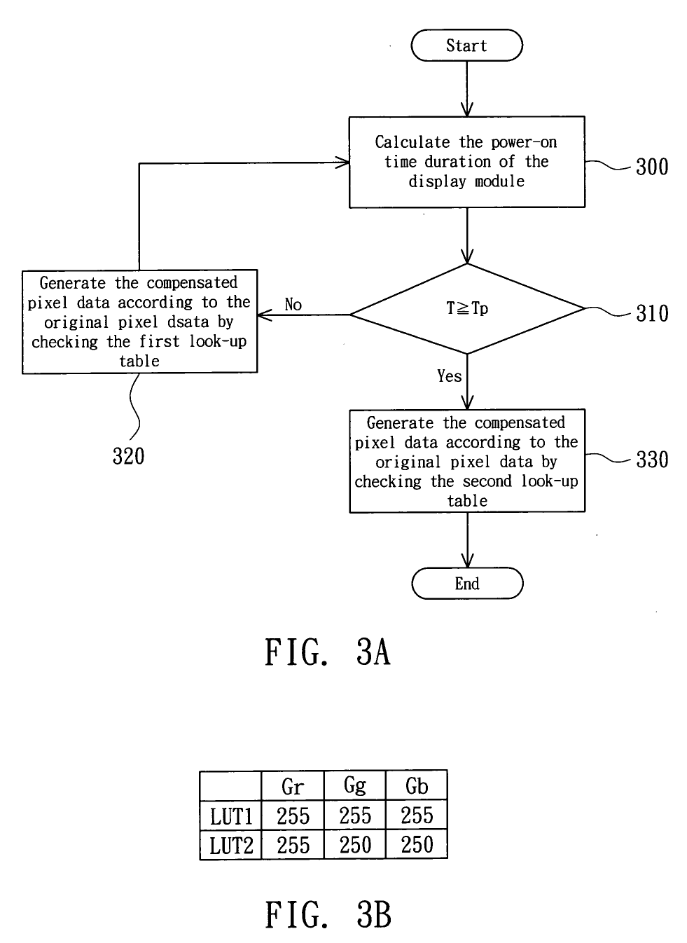

Referring to FIG. 3A, a flow chart of spontaneously color compensating control method of the liquid crystal display according to the preferred embodiment of the invention is shown. First in step 300, calculate the power-on time duration T of the display module 240 by using the timer 230. Afterwards, in step 310, determine whether the power-on time duration T reaches (is not smaller than) a predetermined value Tp. If the power-on time duration T does not reach the predetermined value Tp, continue to the step 320, in which the first look-up table LUT1 is checked to generate compensated pixel data Dpc according to original pixel data Dpo and then return to the step 300. As described above, The EEPROM 220 checks the first look-up table LUT1 to output the calibrating signal Dc1 according to the corresponding time using data Dt and the data requiring signal Sa. The timing controller 210 adjusts the original pixel data Dpo to generate the compensated pixel data Dpc according to the calibrating signal Dc1.

If the power-on time duration T reaches the predetermined value Tp, continue the step 330, in which the original pixel data Dpo is compensated by checking the second look-up table LUT2 to generate the compensated pixel data Dpc. The EEPROM 220 checks the second look-up table Dc2 to output the calibrating signal Dc2 according to the corresponding time using data Dt and the data requiring signal Sa. The timing controller 210 adjusts the original pixel data Dpo to generate the compensated pixel data Dpc according to the calibrating signal Dc2.

As shown in FIG. 3B, the first look-up table LUT1 and the second look-up table LUT2 respectively record percentage of the required red gray level Gr, green gray level Gg, and blue gray level Gb. For example, the Gr, Gg and Gb values of the first look-up table LUT1 are 255, 255, and 255, used for the normal-state display panel where the color compensation of the original pixel data Dpo is not needed. The Gr, Gg and Gb values of the second look-up table LUT2 are 255, 250, and 250. Therefore, when the power-on time duration of the display module 240 reaches the predetermined value Tp, by reducing the green and blue gray level percentage in the pixel data Dpc output by the timing controller 210, the above-mentioned aging effect of the display panel can be reduced.

In the embodiment, the pixel gray levels in the first look-up table LUT1 or the second look-up table LUT2 can be adjusted according to the actual display panel aging situation, and the predetermined value Tp can be also adjusted, for example, the number of compensating periods can be increased and different compensating gray levels in each period are used to dynamically compensate pixel data to maintain the normal color display of the display panel.

Although the liquid crystal display performing color compensation by checking the look-up tables is taken as an example in the invention, the spontaneously color compensating control apparatus of the invention can also spontaneously compensate pixel data according to the power-on time duration of the display module by checking the time-color compensating table set in the timing controller by firmware or even by other mathematical arithmetic methods. Since the gray levels of the pixel data can be spontaneously calibrated to compensate the aging effect of the display module as the power-on time duration of the display reaches the predetermined value, it will not be apart from the skill scope of the invention.

According to the above-mentioned preferred embodiment, the spontaneously color compensating control apparatus has the following advantages. By using the timer disposed in the control apparatus to calculate the power-on time duration of the liquid crystal display, the gray levels of original pixel data can be compensated to maintain the normal color display of the display panel as the display is used for a predetermined period of time. Therefore, the above-mentioned aging effect of the display panel can be reduced and the liquid crystal display lifetime can be elongated by such simple circuit design.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for performing spontaneous color compensation on original pixel data and outputting compensated pixel data to a display module accordingly, comprising:
a timer for providing power-on time duration of the display module; and
a controller for receiving the original pixel data and outputting the compensated pixel data, wherein the timing controller is adapted to adjust gray levels of the original pixel data so as to output the compensated pixel data according to the power-on time duration of the display module.

2. The apparatus according to claim 1, wherein the controller is configured to reduce green gray levels and blue gray levels of the original pixel data when the power-on time duration reaches a predetermined value.

3. The apparatus according to claim 1, further comprising a look-up table, wherein the timing controller is configured to output the compensated pixel data according to the look-up table.

4. The apparatus according to claim 3, further comprising an electrically erasable & programmable read-only memory (EEPROM) for storing the look-up table.

5. The apparatus according to claim 4, wherein the EEPROM is configured to output a calibrating signal by checking the corresponding look-up table for the controller to adjust the original pixel data and generate the compensated pixel data according to the power-on time duration after receiving a data requiring signal output by the controller.

6. The apparatus according to claim 4, wherein the timer is coupled to the EEPROM.

7. The apparatus according to claim 1, wherein the timer is coupled to the controller.

8. A spontaneously color compensating control apparatus for performing spontaneous color compensation on original pixel data and outputting compensated pixel data to a display module accordingly, the control apparatus comprising:
a timer for providing power-on time duration of the display module;
a controller for receiving the original pixel data and outputting a data requiring signal; and
a compensating control unit, comprising a look-up table, for checking the look-up table to output a corresponding calibrating signal according to the data requiring signal and the power-on time duration.

9. The control apparatus according to claim 8, wherein the controller is coupled to the timer for receiving time using data corresponding to the power-on time duration and combining the time using data into the data requiring signal to output.

10. The control apparatus according to claim 8, wherein the compensating control unit is coupled to the timer for receiving time using data corresponding to the power-on time duration.

11. The control apparatus according to claim 8, wherein the compensating control unit comprises an Electrically Erasable Programmable Read-Only Memory (EEPROM) for storing the look-up table.

12. A spontaneously color compensating control method for performing spontaneous color compensation on original pixel data and outputting compensated pixel data to a display module accordingly, the method comprising:
calculating power-on time duration of the display module; and
adjusting gray levels of the original pixel data to generate the compensated pixel data according to the power-on time duration.

13. The control method according to claim 12, wherein the step of adjusting the gray levels of the original pixel data comprises reducing green gray levels and blue gray levels of the original pixel data to generate the compensated pixel data.

14. The control method according to claim 12, wherein the step of adjusting the gray levels of the original pixel data comprises using the corresponding look-up table to compensate the gray levels of the original pixel data.

15. The control method according to claim 14, wherein the step of using the corresponding look-up table to compensate the original pixel data comprises:
determining whether the power-on time duration reaches a predetermined value.

16. The control method according to claim 15, wherein the gray levels of the original data are compensated in accordance with a first look-up table if the power-on time duration does not reach the predetermined value.

17. The control method according to claim 16, wherein the gray levels of the original data are compensated in accordance with a second look-up table if the power-on time duration reaches the predetermined value.

18. A spontaneously color compensating control method for performing spontaneous color compensation on original pixel data and outputting compensated pixel data to a display module accordingly, the control method comprising:
providing power-on time duration of the display module;
providing a data requiring signal;
providing a calibrating signal by checking a look-up table according to the data requiring signal and the power-on time duration; and
compensating the original pixel data according to the calibrating signal.

19. The control method according to claim 18, wherein the step of providing the calibrating signal by checking the look-up table comprising:
providing the calibrating signal in accordance with a first look-up table if the power-on time duration does not reach the predetermined value.

20. The control method according to claim 19, wherein the step of providing the calibrating signal by checking the look-up table comprising:
providing the calibrating signal in accordance with a second look-up table if the power-on time duration reaches the predetermined value.
